(19) United States
(12) Patent Application Publication
(10) Pub. No.: US 2026/0259908 A1
(43) Pub. Date: Sep. 3, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventors: Toshinori ARAKI, Tokyo (JP); Ryo FURUKAWA, Tokyo (JP); Kazuya KAKIZAKI, Tokyo (JP); Yuto MATSUNAGA, Tokyo (JP)

(73) Assignee: NEC Corporation, Tokyo (JP)

(21) Appl. No.: 19/543,061

(22) Filed: Feb. 18, 2026

(30) Foreign Application Priority Data
Feb. 28, 2025 (JP) 2025-031377

(51) Int. Cl. G06F 16/3332; G06F 40/279; G06F 40/40

(52) U.S. Cl. CPC G06F 16/3334; G06F 40/279; G06F 40/40

(57) ABSTRACT

In the information processing apparatus, the extraction unit extracts key information, which is main information of the content, from the content. The conversion unit converts the key information into a converted key information from a different viewpoint. The search unit searches for and outputs related information related to the converted key information.

### INCORPORATION BY REFERENCE

This application is based upon and claims the benefit of priority from Japanese Patent Application 2025-031377, filed on February 28, 2025, the disclosure of which is incorporated herein in its entirety by reference.

### TECHNICAL FIELD

The present disclosure relates to analysis of information.

### BACKGROUND ART

Various types of content are published daily through media and social networking services (SNS). However, published information includes misinformation (incorrect information provided unintentionally) and disinformation (false information created intentionally). As a countermeasure against such misinformation and disinformation, reliability evaluation (fact-checking) by experts is effective.

In the news distribution system described in JP2024-015904, a predetermined expert is requested to perform fact-checking on a news article, and if the expert’s evaluation is affirmative, a fairness score of the article is increased. Accordingly, a user can determine whether to trust the news article with reference to the score.

### SUMMARY

However, fact-checking by experts requires significant time, effort, and cost for human analysis of content, and therefore there is a problem in that the workload for evaluating the reliability of content is large.

One object of the present disclosure is to efficiently collect information from multiple perspectives related to content.

According to an example aspect of the present invention, there is provided an information processing apparatus comprising:

an extraction means configured to extract, from content, key information that is main information of the content;

a conversion means configured to convert the key information into a converted key information from a viewpoint different from a viewpoint of the key information; and

a search means configured to search for and output related information related to the converted key information.

According to another example aspect of the present invention, there is provided an information processing method executed by a computer, the method comprising:

extracting, from content, key information that is main information of the content;

converting the key information into a converted key information from a viewpoint different from a viewpoint of the key information; and

searching for and outputting related information related to the converted key information.

According to still another example aspect of the present invention, there is provided a program causing a computer to execute processing comprising:

extracting, from content, key information that is main information of the content;

converting the key information into a converted key information from a viewpoint different from a viewpoint of the key information; and

searching for and outputting related information related to the converted key information.

According to the present disclosure, it is possible to efficiently collect information from multiple perspectives related to content.

### BRIEF DESCRIPTION OF THE DRAWINGS

FIG. 1 illustrates an overall configuration of an information analysis support system according to the present disclosure.

FIG. 2 is a block diagram illustrating a hardware configuration of an information analysis support apparatus.

FIG. 3 is a block diagram illustrating a functional configuration of the information analysis support apparatus.

FIG. 4 illustrates an example of output of related information.

FIG. 5 is a flowchart of information analysis support processing.

FIG. 6 is a block diagram illustrating a functional configuration of an information processing apparatus according to the present disclosure.

FIG. 7 is a flowchart of processing performed by the information processing apparatus.

### EXAMPLE EMBODIMENTS

Preferred example embodiments of the present disclosure will be described with reference to the accompanying drawings.

### First Example Embodiment

### Basic Concept

As described above, fact-checking by experts requires time, effort, and cost for human analysis of content. Therefore, it is desirable to reduce the workload involved in evaluating the reliability of content. In the present disclosure, in fact-checking, collection of evaluation information for determining the reliability of the content to be evaluated is performed by automated searches or the like. Accordingly, the workload of reliability evaluation can be reduced.

When searching for evaluation information for determining reliability, in general, main information (statements or key points) is extracted from the content to be evaluated, and searches related to the extracted information are performed. However, if searches are performed based only on the main information extracted from the content to be evaluated, information that aligns with the key points or statements of the content to be evaluated tends to be collected. As a result, information from viewpoints different from the key points or statements of the content to be evaluated is less likely to be collected, which may lead to an unfair evaluation in terms of information reliability evaluation.

Accordingly, in the present disclosure, first, main information (hereinafter referred to as “key information”) is extracted from the content to be evaluated. Then, the extracted key information is converted into information from a different viewpoint, and searches related to the information from the different viewpoint are performed to output search results. As a result, information from viewpoints different from the key points or statements of the content to be evaluated can be collected, making it possible to fairly evaluate the reliability of the information. Here, different viewpoints include differences in positions or roles. For example, such differences include differences between a supervisor and a subordinate in a company, and differences between an orderer and a contractor in a business context. Further, different viewpoints include differences arising from differences in culture, region, religion, and the like.

### Overall Configuration

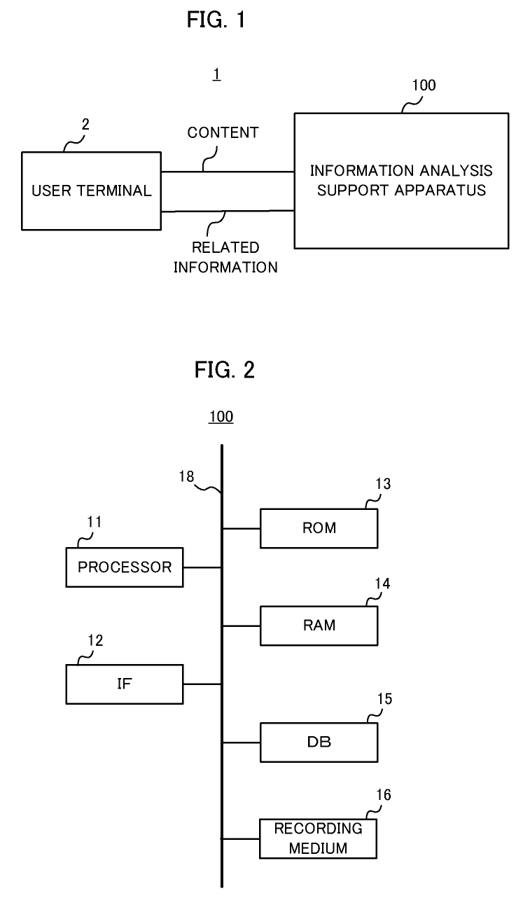

FIG. 1 illustrates an overall configuration of an information analysis support system according to the present disclosure. An information analysis support system 1 is a system for supporting a user in evaluating the reliability of information, and includes a user terminal 2 and an information analysis support apparatus 100. The information analysis support apparatus 100 is an example of the information processing apparatus of the present disclosure, and is configured by, for example, a server apparatus. The user terminal 2 is a terminal device such as a personal computer used by a user who evaluates the reliability of information. The user terminal 2 and the information analysis support apparatus 100 are communicatively connected to each other via a network or the like.

A user inputs content to be evaluated for reliability into the information analysis support apparatus 100 via the user terminal 2. The information analysis support apparatus 100 searches for information related to the content input from the user terminal 2 and transmits obtained related information to the user terminal 2. At this time, as described above, the information analysis support apparatus 100 performs searches based on information from viewpoints different from the key information in the content to be evaluated, and acquires related information. Accordingly, the user can obtain multifaceted information related to the content to be evaluated, and can fairly evaluate the reliability of the content to be evaluated based on such information.

### Hardware Configuration

FIG. 2 is a block diagram illustrating a hardware configuration of the information analysis support apparatus 100. As illustrated, the information analysis support apparatus 100 includes a processor 11, an interface (IF) 12, a ROM (Read Only Memory) 13, a RAM (Random Access Memory) 14, a database (DB) 15, and a recording medium 16. The respective components are connected to each other, for example, via a bus 18.

The processor 11 is a computer such as a CPU (Central Processing Unit), and controls the overall operation of the information analysis support apparatus 100 by executing programs prepared in advance. Specifically, the processor 11 may include a CPU, a GPU (Graphics Processing Unit), a DSP (Digital Signal Processor), an MPU (Micro Processing Unit), an FPU (Floating Point Unit), a PPU (Physics Processing Unit), a TPU (Tensor Processing Unit), a quantum processor, a microcontroller, or any combination thereof.

The processor 11 loads programs stored in the ROM 13 or the recording medium 16 into the RAM 14 and executes various processes coded in the programs. The processor 11 functions as a part or the entirety of the information analysis support apparatus 100. Specifically, the processor 11 executes information analysis support processing described below.

The IF 12 transmits and receives data to and from external devices. Specifically, the information analysis support apparatus 100 receives content to be evaluated from the user terminal 2 via the IF 12. Further, the information analysis support apparatus 100 transmits related information obtained through searches to the user terminal 2 via the IF 12.

The ROM 13 stores various programs to be executed by the processor 11. The RAM 14 is used as a working memory during execution of various processes by the processor 11.

The DB 15 stores various algorithms, data, machine learning models, language models, and the like used when the information analysis support apparatus 100 executes information analysis support processing described below.

The recording medium 16 is a non-volatile and non-transitory storage medium such as a disk-shaped recording medium or a semiconductor memory. The recording medium 16 may be configured to be detachable from the information analysis support apparatus 100. The recording medium 16 stores various programs executed by the processor 11.

### Functional Configuration

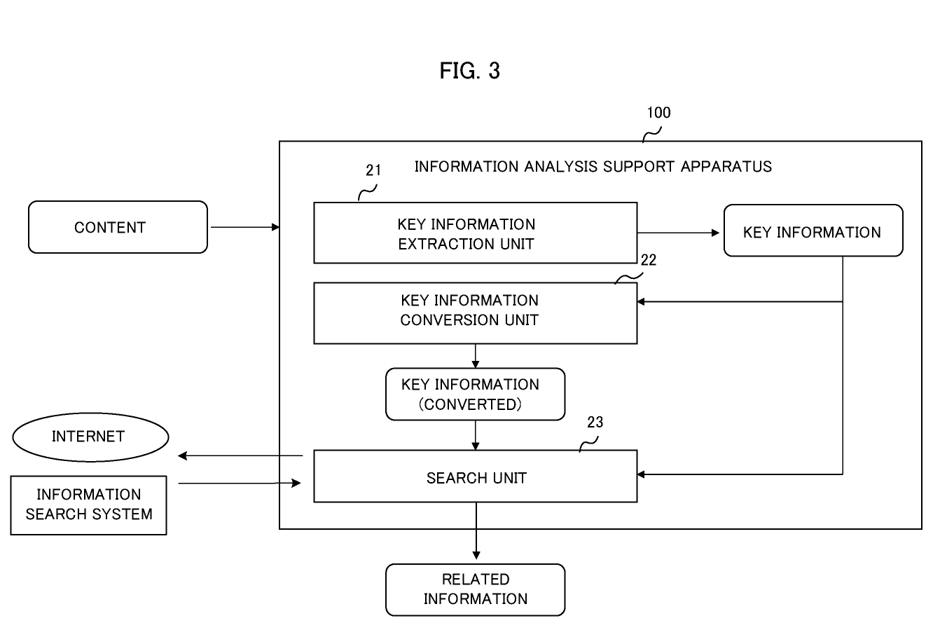

FIG. 3 is a block diagram illustrating a functional configuration of the information analysis support apparatus 100. The information analysis support apparatus 100 includes a key information extraction unit 21, a key information conversion unit 22, and a search unit 23.

Content to be evaluated is input to the information analysis support apparatus 100. The content to be evaluated may be in any form such as text, images, videos, or audio.

The key information extraction unit 21 extracts key information from the input content. The “key information” refers to main information contained in the content, and specifically includes one or more of a key point, a statement, a summary, an abstract, a statement, an assertion, an opinion, and the like of the content. The key information extraction unit 21 extracts key information from the content using a language model. The “language model” is a model that outputs responses in language to an input language. The input language and the output language do not necessarily have to be the same. The language model may output responses in a format different from language, such as images or audio. The language model is, for example, an LLM (Large Language Model).

Specifically, in a case where the input content is text, the key information extraction unit 21 extracts key information from the content using a machine-learned language model. As the machine-learned language model, for example, a model trained by machine learning on sequences of components (such as words) in sentences, or on sequences of sentences in text, may be applied. From the viewpoint of obtaining highly accurate output, it is preferable to use an LLM generated by machine learning using a large-scale language corpus. For example, as an LLM used for extracting key information such as statements in content, GPT (Generative Pre-Trained Transformer), which outputs sentences including an input character string by predicting a character string with a high probability following the input character string, may be used. In addition, as LLMs used for extracting key information, for example, T5 (Text-to-Text Transfer Transformer), BERT (Bidirectional Encoder Representations from Transformers), RoBERTa (Robustly optimized BERT approach), ELECTRA (Efficiently Learning an Encoder that Classifies Token Replacements Accurately), and the like may also be used.

On the other hand, in a case where the input content is an image or a video, the key information extraction unit 21 converts the content of the image or video into text using a machine-learned image-language model, and extracts key information from the text using a machine-learned language model. In a case where the input content is audio, the key information extraction unit 21 converts the audio content into text using a machine-learned transcription model, and extracts key information from the text using a machine-learned language model.

Examples of models for converting image content into text include BLIP (Bootstrap Language Image Pre-Training). Examples of models for converting video content into text include Video-LLaVA. Examples of models for converting audio content into text include Whisper. Further, as a method for extracting text contained in a video, optical character recognition (OCR) techniques such as ViTSTR (Vision Transformer for Fast and Efficient Scene Text Recognition) may be used. In addition, text may be generated from non-text elements using, for example, an image-language model (VLM: Vision Language Model) that accepts multiple modalities as inputs and generates text.

When extracting key information from text content using a language model, the key information extraction unit 21 may input the text to the language model together with, for example, the following instruction (prompt):

“A text for which truth or falsity is to be determined is provided. Your task is to comprehensively analyze the given text and accurately identify and extract statements included in the input. Here, a statement refers to an opinion whose truth or falsity can be determined. If the text includes multiple statements, extract all of the statements.”

The key information extraction unit 21 outputs the key information extracted as described above to the key information conversion unit 22 and the search unit 23.

The key information conversion unit 22 generates key information different from the statements or key points contained in the input content (hereinafter also referred to as “converted key information”) by converting viewpoints of statements or opinions included in the key information, or by converting whether such statements are affirmed or denied. Specifically, the key information conversion unit 22 converts the key information by, using a machine-learned language model, replacing a subject of a statement or key point included in the key information with another subject related to the subject, changing a degree of emphasis of a modified portion, or reversing affirmation or denial of a predicate. Here, a “predicate” refers to one of sentence components that describes, with respect to content expressed by a subject (or a subject part), “what state it is in” or “what it does.”

For example, in a case where the input content is a statement by a politician regarding a legal amendment, the key information conversion unit 22 may generate, based on the key information, an opinion of a legal expert or an opinion from a standpoint opposing the legal amendment. Further, in a case where the input content is a statement by management of a company, the key information conversion unit 22 may generate, based on the key information, statements or opinions from the standpoint of workers of the company.

Further, in a case where the input content is a statement that a certain tax increase is necessary, the key information conversion unit 22 may generate, based on the key information, a statement that a tax increase is unnecessary or a statement that a tax reduction is necessary. The key information conversion unit 22 may also generate a statement that a tax increase is necessary but with a different tax rate. For example, in a case where the input content states a 10% tax increase, the key information conversion unit 22 may generate converted key information stating a 5% tax increase.

When converting key information using a language model, the key information conversion unit 22 may input the text to the language model together with, for example, the following instruction (prompt):

“A text is provided. Your task is to comprehensively analyze the given text and convert statements included in the text into statements that can be assumed as different opinions, different viewpoints, reversed affirmation or denial, or opposing statements.”

The key information conversion unit 22 outputs the converted key information generated as described above to the search unit 23.

The search unit 23 receives the key information output from the key information extraction unit 21 and the converted key information output from the key information conversion unit 22. The search unit 23 searches for related information using the key information and the converted key information as search keywords, and outputs the obtained related information in association with the key information or the converted key information. As a search method, the search unit 23 may use an Internet search engine or an information search system constructed for in-house use.

The search unit 23 may output, instead of the related information itself obtained by searching, links to each piece of related information, or may output summaries, statements, key points, or the like for each piece of related information generated by using a language model, an image-language model, a transcription model, or the like, or may output these in combination.

### Example of Output of Related Information

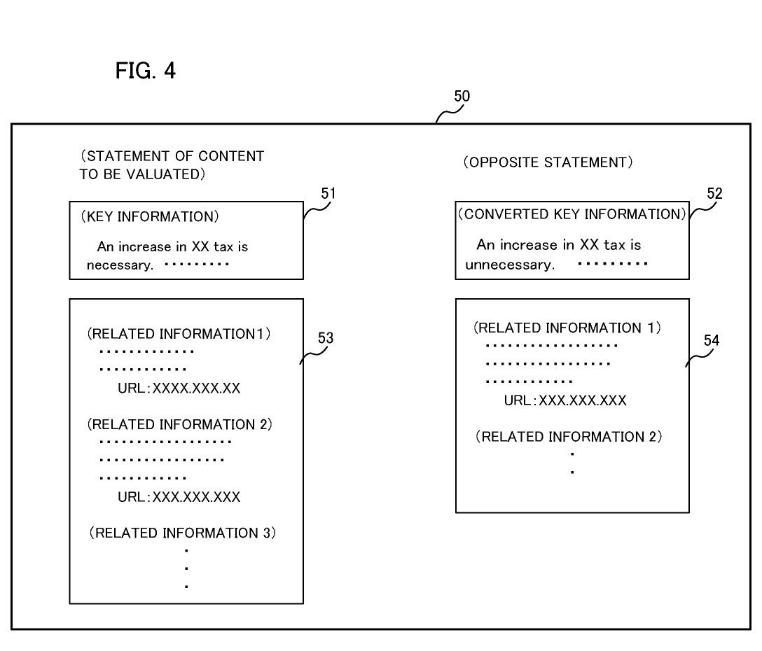

FIG. 4 illustrates an example of output of related information obtained by the information analysis support apparatus 100. FIG. 4 illustrates an example of related information output by the information analysis support apparatus 100 when a user inputs, using the user terminal 2, content stating “an increase in XX tax” as content to be evaluated.

In this example, the key information extraction unit 21 extracts key information 51 including a statement that “an increase in XX tax is necessary” from the content to be evaluated. Further, the key information conversion unit 22 generates converted key information 52 including an opposing statement “an increase in XX tax is unnecessary” from the key information 51. The search unit 23 searches for related information using the key information 51 and the converted key information 52, and acquires related information 53 corresponding to the key information 51 and related information 54 corresponding to the converted key information 52. The information analysis support apparatus 100 then displays the key information 51 in association with the corresponding related information 53, and displays the converted key information 52 in association with the corresponding related information 54.

As described above, in the information analysis support apparatus 100, the key information conversion unit 22 converts statements or key points of the input content into information from different viewpoints, and such converted information is used as search keywords by the search unit 23. Accordingly, it becomes possible to collect information related to the input content from multifaceted viewpoints.

### Information Analysis Support Processing

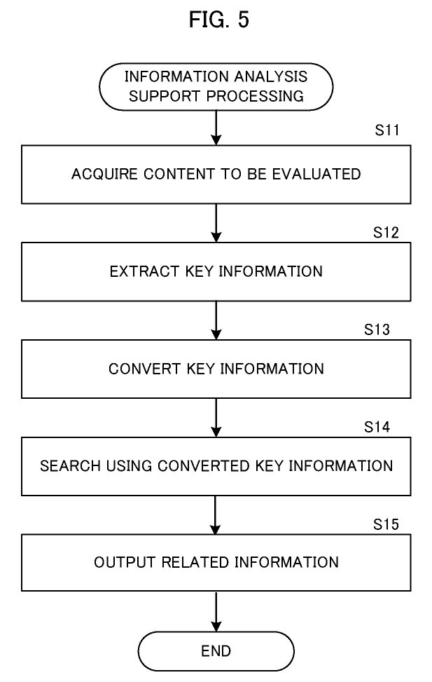

Next, processing executed by the information analysis support apparatus 100 will be described. FIG. 5 is a flowchart of information analysis support processing. This processing can be realized by a processor executing programs prepared in advance and operating as the respective elements illustrated in FIG. 3. Note that the entity that executes each step of the information analysis support processing may be the processor 11 of the information analysis support apparatus 100 illustrated in FIG. 2, may be a processor provided in another apparatus, or may be processors provided in different apparatuses for respective steps.

First, when content to be evaluated is input by a user, the key information extraction unit 21 acquires the content to be evaluated (step S11). Next, the key information extraction unit 21 extracts key information from the content to be evaluated (step S12). In a case where the input content is other than text, the key information extraction unit 21 converts the content into text. Then, the key information extraction unit 21 inputs the obtained text into a language model to extract key information including key points, statements, and the like of the input content.

Next, the key information conversion unit 22 converts the extracted key information into information from a different viewpoint (step S13). Specifically, the key information conversion unit 22 converts the key information by using a language model to replace a subject of a statement or key point included in the key information with another subject, change a degree of emphasis of a modified portion, or reverse affirmation or denial of a predicate.

Next, the search unit 23 performs a search using the key information and the converted key information to acquire related information (step S14). Then, the search unit 23 outputs the obtained related information to the user terminal 2 in association with the key information or the converted key information (step S15). Thereafter, the information analysis support processing ends.

### Modification

In the above example, the content to be evaluated is input by a user. However, application of the present disclosure is not limited thereto. For example, the information analysis support apparatus 100 may periodically acquire news, articles, or the like from a predetermined website, perform the information analysis support processing, and acquire and output or display related information.

### Application Examples

The information analysis support of the present disclosure can be applied to analysis support of information and acquisition of related information in various fields. For example, the information analysis support of the present disclosure can be applied to medical diagnosis support in the medical field. Specifically, a physician’s diagnostic result regarding a patient’s symptoms or medical history may be used as content to be evaluated, and diverse diagnostic results such as medical literature or second-opinion diagnostic results may be provided as related information. Further, the information analysis support of the present disclosure can be applied to a news analysis system. This makes it possible to construct a system that generates opinions from various opposing viewpoints, such as approval and disapproval, with respect to a certain news item or article, and aggregates such opinions. Furthermore, the information analysis support of the present disclosure can also be applied to a research system in the field of education. This makes it possible to generate various theories regarding a certain research topic and to collect and compile papers and articles from multiple perspectives.

### Second Example Embodiment

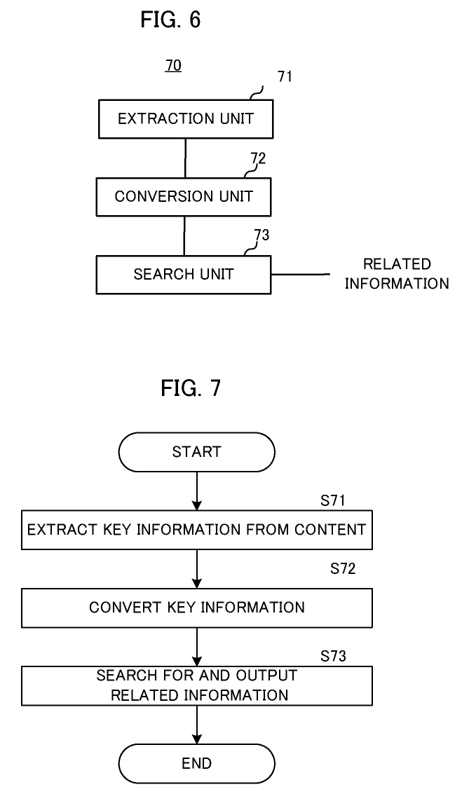

FIG. 6 is a block diagram illustrating a functional configuration of an information processing apparatus according to a second example embodiment. An information processing apparatus 70 includes an extraction unit 71, a conversion unit 72, and a search unit 73.

FIG. 7 is a flowchart of processing performed by the information processing apparatus according to the second example embodiment. The extraction unit 71 extracts key information, which is main information of the content, from the content (step S71). The conversion unit 72 converts the key information into a converted key information from a different viewpoint (step S72). The search unit 73 searches for and outputs related information related to the converted key information (step S73).

According to the information processing apparatus 70 of the second example embodiment, it becomes possible to efficiently collect information from multiple perspectives related to the input content.

A part or all of the example embodiments described above may also be described as the following supplementary notes, but not limited thereto.

### Supplementary note 1

An information processing apparatus comprising:

an extraction means configured to extract, from content, key information that is main information of the content;

a conversion means configured to convert the key information into a converted key information from a viewpoint different from a viewpoint of the key information; and

a search means configured to search for and output related information related to the converted key information.

### Supplementary note 2

The information processing apparatus according to claim 1, wherein the key information includes a key point of the content or a statement in the content.

### Supplementary note 3

The information processing apparatus according to claim 2, wherein the conversion means changes a viewpoint of the key point or the statement to another viewpoint.

### Supplementary note 4

The information processing apparatus according to claim 2, wherein the conversion means reverses affirmation or denial of the key point or the statement.

### Supplementary note 5

The information processing apparatus according to claim 2, wherein the conversion means changes a degree of strength of the key point or the statement.

### Supplementary note 6

The information processing apparatus according to any one of claims 1 to 5, wherein the conversion means generates the converted key information by inputting, to a language model, the key information and an instruction that instructs converting the key information into the converted key information from a different viewpoint.

### Supplementary note 7

The information processing apparatus according to any one of claims 1 to 6, wherein the extraction means extracts the key information from the content by inputting, to a language model, the content and an instruction that instructs extracting the key information from the content.

### Supplementary note 8

The information processing apparatus according to claim 7,

wherein the content is any one of text, an image, a video, or audio, and

wherein, in a case where the content is other than text, the extraction means converts the content into text and then inputs the converted text to the language model.

### Supplementary note 9

An information processing method executed by a computer, the method comprising:

extracting, from content, key information that is main information of the content;

converting the key information into a converted key information from a viewpoint different from a viewpoint of the key information; and

searching for and outputting related information related to the converted key information.

### Supplementary note 10

A program causing a computer to execute processing comprising:

extracting, from content, key information that is main information of the content;

converting the key information into a converted key information from a viewpoint different from a viewpoint of the key information; and

searching for and outputting related information related to the converted key information.

Some or all of the configurations described in Supplementary Notes 2 to 8 dependent on the above-described Supplementary Note 1 can also be dependent on Supplementary Notes 9 and 10 by a dependency relationship similar to that of Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1 Information analysis support system
2 User terminal
11 Processor
21 Key information extraction unit
22 Key information conversion unit
23 Search unit
100 Information analysis support apparatus

1. An information processing apparatus comprising:
a memory configured to store instructions; and
a processor configured to execute the instructions to:
extract, from content, key information that is main information of the content;
convert the key information into a converted key information from a viewpoint different from a viewpoint of the key information; and
search for and output related information related to the converted key information.

2. The information processing apparatus according to claim 1, wherein the key information includes a key point of the content or a statement in the content.

3. The information processing apparatus according to claim 2, wherein the processor changes a viewpoint of the key point or the statement to another viewpoint.

4. The information processing apparatus according to claim 2, wherein the processor reverses affirmation or denial of the key point or the statement.

5. The information processing apparatus according to claim 2, wherein the processor changes a degree of strength of the key point or the statement.

6. The information processing apparatus according to claim 1, wherein the processor generates the converted key information by inputting, to a language model, the key information and an instruction that instructs converting the key information into the converted key information from a different viewpoint.

7. The information processing apparatus according to claim 1, wherein the processor extracts the key information from the content by inputting, to a language model, the content and an instruction that instructs extracting the key information from the content.

8. The information processing apparatus according to claim 7,
wherein the content is any one of text, an image, a video, or audio, and
wherein, in a case where the content is other than text, the processor converts the content into text and then inputs the converted text to the language model.

9. An information processing method executed by a computer, the method comprising:
extracting, from content, key information that is main information of the content;
converting the key information into a converted key information from a viewpoint different from a viewpoint of the key information; and
searching for and outputting related information related to the converted key information.

10. A non-transitory computer-readable recording medium storing a program, the program causing a computer to execute processing comprising:
extracting, from content, key information that is main information of the content;
converting the key information into a converted key information from a viewpoint different from a viewpoint of the key information; and
searching for and outputting related information related to the converted key information.
